(19) United States
(12) Patent Application Publication
(10) Pub. No.: US 2025/0387730 A1
(43) Pub. Date: Dec. 25, 2025

(54) DEIONIZATION FILTER ASSEMBLY WITH CYLINDER-IN-CYLINDER DESIGN

(71) Applicant: Cummins Filtration Inc., Nashville, TN (US)

(72) Inventors: Shantanu Sanjay Ghatnekar, Pune (IN); Balasaheb Mahadev Bhittam, Kolhapur (IN); Dhananjay Kumar Singh, Pune (IN)

(73) Assignee: Cummins Filtration Inc., Nashville, TN (US)

(21) Appl. No.: 18/877,815

(22) PCT Filed: Jun. 27, 2023
(86) PCT No.: PCT/US2023/026320

§ 371 Date: Dec. 20, 2024

(30) Foreign Application Priority Data
Jun. 29, 2022 (IN) 202241037391

(51) Int. Cl. B01D 15/22; B01D 15/36; H01M 8/04044

(52) U.S. Cl. CPC B01D 15/22; B01D 15/362; B01D 15/363; H01M 8/04044

(57) ABSTRACT

A deionization filter assembly includes an outer cylinder, an inner cylinder. an endcap, and a screen. The outer cylinder includes a first outer end and a second outer end and is configured to contain an outer resin bed. The inner cylinder is positionable within the outer cylinder and includes a first inner end and a second inner end. The inner cylinder is configured to contain an inner resin bed. The endcap is positionable along the first outer end of the outer cylinder and the first inner end of the inner cylinder and includes an inlet and an outlet. The screen is positionable between the endcap and the outer cylinder and the inner cylinder.

### CROSS-REFERENCE TO RELATED PATENT APPLICATIONS

This Application claims the benefit of and priority to Indian Provisional Patent Application No. 202241037391, filed on Jun. 29, 2022, entitled DEIONIZATION FILTER ASSEMBLY WITH CYLINDER-IN-CYLINDER DESIGN, the contents of which are incorporated herein by reference in its entirety.

### FIELD

The present application relates generally to deionization filter assemblies for removing ions from a fluid.

### BACKGROUND

In fuel cell systems, the neutralization of ions within a coolant can improve the life of the coolant and the fuel cells which are cooled by the coolant. However, ion exchange resin-based deionization filters can suffer from a high pressure drop due to the resin bed designs as well as an underutilization of the resin due to suboptimal filter designs.

### SUMMARY

Various embodiments provide for a deionization filter assembly that includes an outer cylinder, an inner cylinder, an endcap, and a screen. The outer cylinder includes a first outer end and a second outer end and is configured to contain an outer resin bed. The inner cylinder is positionable within the outer cylinder and includes a first inner end and a second inner end. The inner cylinder is configured to contain an inner resin bed. The endcap is positionable along the first outer end of the outer cylinder and the first inner end of the inner cylinder and includes an inlet and an outlet. The screen is positionable between the endcap and the outer cylinder and the inner cylinder.

Another embodiment of the present disclosure relates to a deionization filter assembly including an outer cylinder, an inner cylinder, an outer resin bed, and an inner resin bed. The outer cylinder defines an open end and a closed end. The inner cylinder is positioned within the outer cylinder and is spaced radially apart from the outer cylinder to define an annulus therebetween. The inner cylinder defines an inner cavity that is fluidly coupled to the annulus at the closed end of the outer cylinder. The outer resin bed is contained within the annulus and the inner resin bed is contained within the inner cavity.

Yet another embodiment of the present disclosure relates to a method of assembling a deionization filter assembly. The method includes positioning an inner cylinder within an outer cylinder to define an annulus therebetween and so that the annulus is fluidly coupled to an inner cavity of the inner cylinder at a closed end of the outer cylinder. The method also includes placing an inner resin bed within the inner cavity and placing an outer resin bed within the annulus.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a cross-sectional, perspective view of a deionization (DI) filter assembly, according to an embodiment.

FIG. 2 is an exploded view of the DI filter assembly of FIG. 1.

FIG. 3 is a cross-sectional, perspective view of an outer cylinder and an inner cylinder of the DI filter assembly of FIG. 1.

FIG. 4 is a perspective view of a screen of the DI filter assembly of FIG. 1.

FIG. 5 is a cross-sectional view of an endcap of the DI filter assembly of FIG. 1.

FIG. 6A is a schematic view of the DI filter assembly of FIG. 1 shown positioned within a coolant system.

FIG. 6B is a schematic view of the DI filter assembly of FIG. 6A.

FIG. 7 is a flow diagram of a method of assembling a DI filter assembly, according to an embodiment.

### DETAILED DESCRIPTION

Referring to the figures generally, various embodiments disclosed herein relate to a deionization filter assembly that uses ion exchange resins as the primary method for removing organic, inorganic, metallic, and nonmetallic ions from a fluid (e.g., coolant). Since ion exchange resins can be costly, it is beneficial to fully utilize the full resin capacity before discarding or regenerating the resin. As described further herein, the various embodiments of the deionization filter assembly described herein can (i) maximize or otherwise increases the capacity and utilization of ion exchange resins, and (ii) reduce pressure drop compared to various conventional deionization filters.

### Example Deionization Filter Assembly

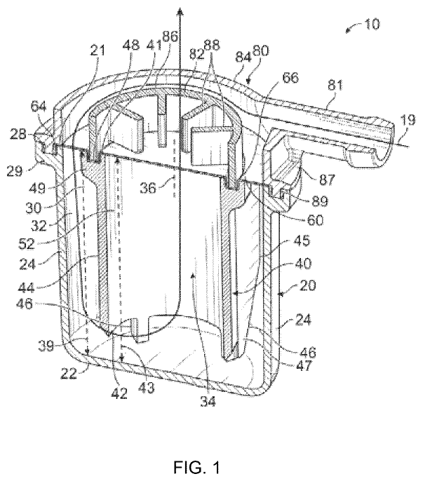

FIG. 1 shows a deionization (DI) filter assembly 10 for removing ions from a fluid, according to an example embodiment. The fluid may be, for example, coolant or water. The coolant may be a part of a fuel cell system or a similar system that uses a low conductivity solution.

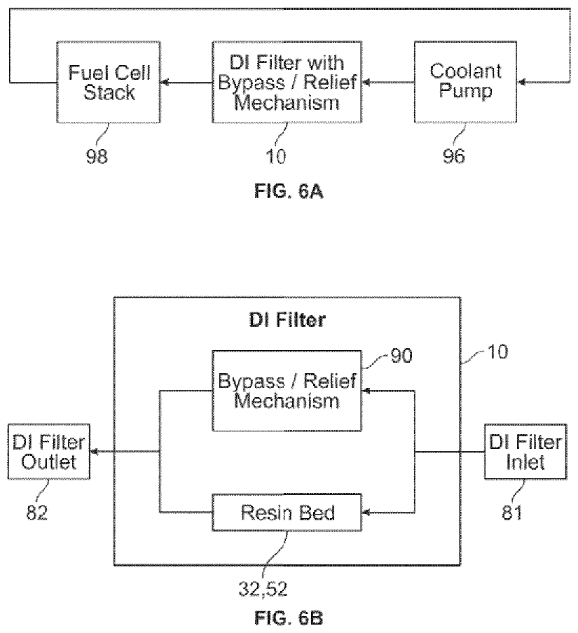

The DI filter assembly 10 includes an outer cylinder 20, an inner cylinder 40, a screen 60, and an endcap 80. Optionally, the DI filter assembly 10 may also include a pressure relief mechanism 90, as described in further detail with respect to FIG. 6B. In the embodiment of FIG. 1, the outer cylinder 20 and the inner cylinder 40 are concentric (i.e., the inner cylinder 40 is positioned and housed within the outer cylinder 20 and shares the same central axis as the outer cylinder 20), thereby forming a cylinder-in-cylinder design of the DI filter assembly 10. The outer cylinder 20 and the inner cylinder 40 are joined together with a single endcap (i.e., the endcap 80) and a single screen (i.e., the screen 60). The configuration of the inlet 81 of the endcap 80 (in particular, the positioning of the inlet 81 tangentially with respect to the outer cylinder 20) directs a fluid 19 to flow into the outer cylinder 20 tangentially. The configuration of the outlet 82 of the endcap 80 (in particular, the taper of the outlet 82) reduces pressure loss.

The outer cylinder 20 comprises and is configured to contain an outer resin cartridge or bed 32. The outer resin bed 32 is positioned in an annulus 30 (i.e., the area radially between the outer cylinder 20 and the inner cylinder 40). The annulus 30 is filled with the outer resin bed 32 (filled in an even distribution in particular embodiments). Optionally, the outer resin bed 32 may extend along the entire height of the inside of the outer cylinder 20.

The inner cylinder 40 comprises and is configured to contain an inner resin cartridge or bed 52. The inner cylinder 40 defines an inner cavity 34 that is filled with the inner resin bed 52 (filled in an even distribution in particular embodiments). The inner resin bed 52 may optionally extend along the entire height of the inside of the inner cylinder 40. In the embodiment of FIG. 1, a height 39 of the annulus 30 and the inner cylinder 40 is approximately equal to a height 43 of the inner cavity 34 (e.g., the inner cylinder 40 extends along the entire height of the annulus 30). The inner cavity 34 is fluidly coupled to the annulus 30 by a passage at the second outer end 22 (e.g., a closed end) of the outer cylinder 20. The passage connecting the annulus 30 and the inner area of the inner cylinder 40 also contains an even distribution of resin from a resin bed (e.g., from the outer resin bed 32 and/or from the inner resin bed 52).

The outer resin bed 32 and the inner resin bed 52 each include ion-exchange resin that includes both anion and cation resin in a predetermined mixture ratio. Each of the outer resin bed 32 and the inner resin bed 52 includes a plurality of resin beads. The outer resin bed 32 and the inner resin bed 52 (or the outer cylinder 20 and the inner cylinder 40) may optionally be removable and replaceable from the rest of the DI filter assembly 10.

As shown in FIG. 1, the fluid 19 flows into the DI filter assembly 10 through the inlet 81 of the endcap 80 in a tangential manner, flows axially downwardly through the screen 60 and into the outer resin bed 32 and through the annulus 30, flows radially inwardly through the passage connecting the outer resin bed 32 and the inner resin bed 52, flows axially upwardly through the inner resin bed 52 within the inner cylinder 40 (thereby making an 180° turn as the fluid moves between the outer resin bed 32 and the inner resin bed 52), and flows axially upwardly back through the screen 60 and through the outlet 82 of the endcap 80. Accordingly, the flow direction of the fluid completely changes its axial direction (i.e., approximately 180°) within the outer cylinder 20 during operation. Each of these components are described further herein.

The outer cylinder 20, the inner cylinder 40, the screen 60, and the endcap 80 are assembled together (as shown in FIG. 1), for example with an adhesive (e.g., a glue) or with threads (on each of the components) to form at least one filter assembly seal. As shown in FIG. 1, an outer seal is formed between an outer protrusion 29 of the outer cylinder 20, an outer impression 64 of the screen 60, and an endcap outer circumferential wall 84 of the endcap 80. An inner seal is formed between an inner protrusion 49 of the inner cylinder 40, an inner impression 66 of the screen 60, and an endcap inner circumferential wall 86 of the endcap 80. Each of these components are described further herein. The outer seal and the inner seal prevent fluid (e.g., coolant) or resin beads from leaking out from the DI filter assembly 10, prevent resin beads from escaping out of the DI filter into the coolant circuit, prevent resin beads migrating between the outer cylinder 20 and the inner cylinder 40 (through the first outer end 21 and the first inner end 41), and fluidly separate the inlet 81 and the outlet 82 of the endcap 80 when assembled.

The DI filter assembly 10 can be mounted, for example, using a C clamp or using a dedicated back plate with a bolting feature. It should be appreciated that other mounting methods may be used in various embodiments. The orientation of the DI filter assembly 10 within the fuel cell system can be in any direction as the ribs 46 (as described further herein) and the overall geometry and design features of the DI filter assembly 10 ensure that no flow bypass occurs.

### Example Outer Cylinder

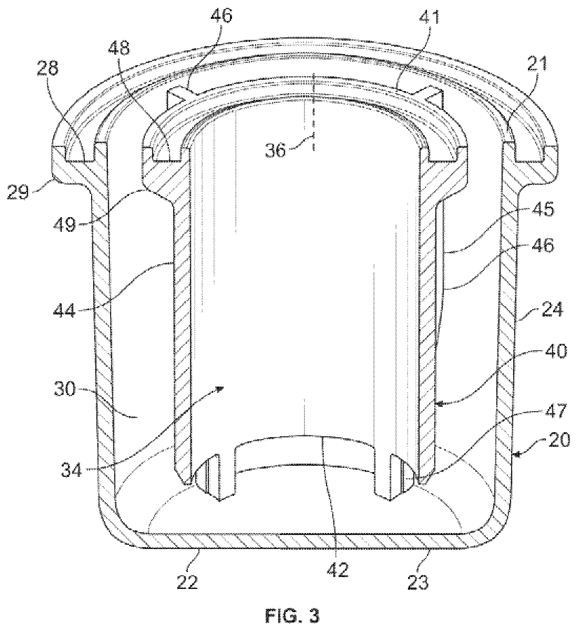

As shown in FIGS. 1 and 3, the outer cylinder 20 encloses, contains, and houses the inner cylinder 40. As described further herein, the inner cylinder 40 is radially spaced apart from the outer cylinder 20, thereby forming an inner area that is referred to herein as an annulus 30. The annulus 30 is positioned radially between the outer cylinder 20 and the inner cylinder 40 for fluid to flow within, as shown in FIG. 1.

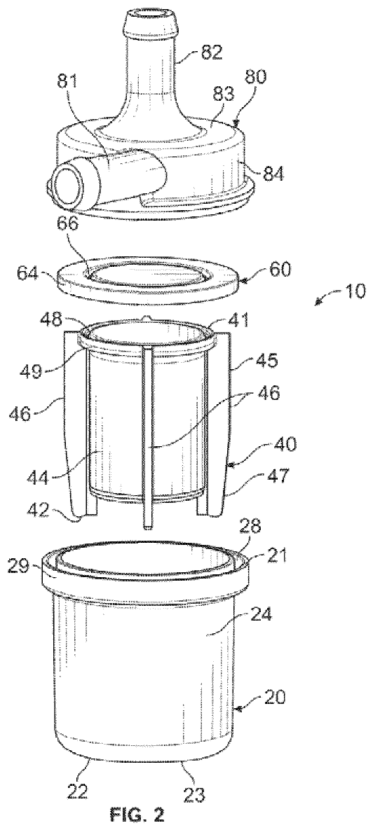

As shown in FIGS. 1-3, the outer cylinder 20 comprises and extends axially between a first outer end 21 (e.g., a first outer axial end, an outer open end, etc.) and a second outer end 22 (e.g., a second outer axial end, and outer closed end, etc.). As shown in FIG. 3, the first outer end 21 of the outer cylinder 20 is open to fluid flow therethrough so that fluid can flow into and out from the outer cylinder 20 through the first outer end 21. The second outer end 22 of the outer cylinder 20 is closed to fluid flow therethrough so that fluid cannot flow into or out from the outer cylinder 20 through the second outer end 22.

The outer cylinder 20 includes an outer cylinder circumferential wall 24 that extends circumferentially around a central axis 36 of the DI filter assembly 10 and around the inner cylinder 40. The outer cylinder circumferential wall 24 extends axially between the first outer end 21 and the second outer end 22. The outer cylinder 20 also includes a lower wall 23 that is positioned along and closes off the second outer end 22 of the outer cylinder 20.

As shown in FIGS. 1-3, the outer cylinder 20 includes an outer protrusion 29 along the first outer end 21 of the outer cylinder circumferential wall 24. The outer protrusion 29 (e.g., the outer radial protrusion, etc.) is positioned along and extends radially outwardly from the outer surface of the outer cylinder circumferential wall 24, along a perimeter edge of the outer cylinder circumferential wall 24 at the first outer end 21. The outer protrusion 29 defines an outer groove 28 along the first outer end 21 that is configured to receive an outer impression 64 of the screen 60, a lower extension 89 of the endcap 80, and a gasket (not shown) or other seal member to form the outer seal between the outer cylinder 20, the screen 60, and the endcap 80, as shown in FIG. 1.

### Example Inner Cylinder

As shown in FIGS. 1 and 3, the inner cylinder 40 is positioned, contained, and mounted within the outer cylinder 20 such that the inner cylinder 40 and the outer cylinder 20 are concentric with each other in a cylinder-in-cylinder arrangement. The cylinder-in-cylinder arrangement increases the effective resin bed height of the DI filter assembly 10. For example, compared to various conventional axial flow DI filter assemblies with approximately the same packaging height as the DI filter assembly 10 of FIG. 1, the diameter of the DI filter assembly 10 is slightly larger, but the effective height of the resin bed is effectively doubled since the fluid flows through the outer cylinder 20 and subsequently through the inner cylinder 40 in the opposite direction (and along a first path through the annulus 30 that is substantially the same height as a second path through the inner cavity 34. Compared to various conventional axial flow DI filter assemblies with approximately the same effective height of the resin bed, the overall packaging height of the DI filter assembly 10 is significantly less and the overall diameter of the DI filter assembly 10 is only slightly increased. The diameters of the outer cylinder 20 and the inner cylinder 40 are sized such that the cross-sectional flow area of the inner cylinder 40 (e.g., the inner cavity 34) is approximately equal to the cross-sectional flow area of the annulus 30.

As shown in FIGS. 1-3, the inner cylinder 40 comprises and extends axially between a first inner end 41 and a second inner end 42. As shown in FIG. 1, both the first inner end 41 and the second inner end 42 of the inner cylinder 40 are open such that fluid can flow into the inner cylinder 40 through the second inner end 42 and out from the inner cylinder 40 through the first inner end 41.

The inner cylinder 40 includes an inner cylinder circumferential wall 44 that extends circumferentially around the center axis 36 of the DI filter assembly 10 and extends substantially parallel to (and within) the outer cylinder circumferential wall 24. The inner cylinder circumferential wall 44 is open to fluid flow axially therethrough from the second inner end 42 through the first inner end 41. As shown in FIGS. 1-3, the inner cylinder 40 includes an inner protrusion 49 along the first inner end 41 of the inner cylinder circumferential wall 44. The inner protrusion 49 (e.g., the inner radial protrusion) is positioned along and extends radially outwardly from the outer surface of the inner cylinder circumferential wall 44, along a perimeter edge of the inner cylinder circumferential wall 44 at the first inner end 41. The inner protrusion 49 defines an inner groove 48 along the first inner end 41 that is configured to receive an inner impression 66 of the screen 60, a lower end of the endcap inner circumferential wall 86 of the endcap 80, and a gasket (not shown) to form a seal between the inner cylinder 40, the screen 60, and the endcap 80, as shown in FIG. 1.

In the embodiment depicted in FIG. 1, the inner cylinder 40 extends along the entire inner length of the outer cylinder 20. In particular, the inner cylinder 40 extends between an inner surface of the lower wall 23 of the outer cylinder 20 and the first outer end 21 of the outer cylinder 20. To maintain the position of the inner cylinder 40 within the outer cylinder 20, the inner cylinder 40 includes at least one inner cylinder rib 46 (preferably a plurality of ribs 46), as shown in FIGS. 1-3. In one embodiment, the ribs 46 are radially spaced apart from each other about the outer surface of the inner cylinder circumferential wall 44. The ribs 46 extend axially along the entire axial length of the inner cylinder 40, between the first inner end 41 and the second inner end 42.

As shown in FIGS. 1-3, each of the ribs 46 includes an axial rib portion 45 and an elevation rib portion 47. In other embodiments, the axial rib portion 45 may be formed by a separate rib from the elevation rib portion 47. The axial rib portions 45 (e.g., the axial ribs, etc.) help maintain the concentricity of the inner cylinder 40 and the outer cylinder 20. The axial rib portions 45 extend radially outwardly from the outer surface of the inner cylinder circumferential wall 44 and are sized and configured to abut the inner surface of the outer cylinder circumferential wall 24 (when assembled). The axial rib portions 45 radially space the inner cylinder circumferential wall 44 and the outer cylinder circumferential wall 24 apart to create the annulus 30.

The elevation rib portions 47 (e.g., the elevation ribs, etc.) extend axially downwardly from the bottom of the inner cylinder circumferential wall 44 (along the second inner end 42) and are sized and configured to abut the inner (upper) surface of the lower wall 23 of the outer cylinder 20 (when assembled). Accordingly, the elevation rib portions 47 axially space the inner cylinder circumferential wall 44 and the inner surface of the lower wall 23 of the outer cylinder 20 apart (elevating the inner cylinder circumferential wall 44 axially above the inner surface of the lower wall 23 of the outer cylinder 20) to create a flow passage connecting the outer resin bed 32 in the annulus 30 and the inner resin bed 52 in the inner area of the inner cylinder 40, as shown in FIGS. 1 and 3.

The height of the elevation rib portions 47 (i.e., the distance between the bottom of the inner cylinder circumferential wall 44 and the opposite end of the elevation rib portion 47) is sized such that the cylindrical flow area formed between the annulus 30 and the inner cavity 34 (due to the elevation rib portions 47) is either approximately equal to or slightly greater than the cross-sectional area of the inner cylinder circumferential wall 44. Such an arrangement reduces flow restriction at the transition between the annulus 30 and the inner cavity 34.

### Example Screen

The screen 60 traps the resin beads of the outer resin bed 32 and the inner resin bed 52 within the outer cylinder 20 and the inner cylinder 40 during the coolant flow. The screen 60 is non-reactive to the ions and the fluid (e.g., the coolant). The screen 60 may diffuse any swirl from the tangential entry of the fluid before the fluid enters the outer resin bed 32, which can improve flow performance in some circumstances. According to various embodiments, the screen 60 is a wire/wire mesh screen.

As shown in FIG. 1, the mesh or screen 60 is positioned axially between the inner and outer cylinders 20, 40 and the endcap 80. In particular, the screen 60 is positionable along the first outer end 21 of the outer cylinder 20 and the first inner end 41 of the inner cylinder 40 and along a bottom side of the endcap 80.

The screen 60 covers the entire first outer end 21 of the outer cylinder 20 and the first inner end 41 of the inner cylinder 40. Since the outer cylinder 20 is closed along the second outer end 22 (with the lower wall 23), the DI filter assembly 10 only includes one single screen (i.e., the screen 60) that is shared between the inlet end and outlet end of the combined resin beds. By using a single screen 60 for both the outer cylinder 20 and the inner cylinder 40, the DI filter assembly 10 forms a less complicated seal between the inlet side and the outlet side of the outer resin bed 32 and the inner resin bed 52.

In one embodiment, the screen 60 comprises a single piece covering the entire first outer end 21 of the outer cylinder 20. In other embodiments, the screen 60 comprises two screen portions that are separate from one another, where a first screen covers the end of the annulus 30 (along the first outer end 21) and a second screen covers the first inner end 41 of the inner cylinder 40. In various embodiments, the opening area of the screen 60 (i.e., the open area between two wires of the screen 60, or both the first screen and the second screen) is at least 50% smaller than the smallest resin bead of the outer resin bed 32 and the inner resin bed 52, which can prevent the loss of resin beads from the DI filter assembly 10 during operation.

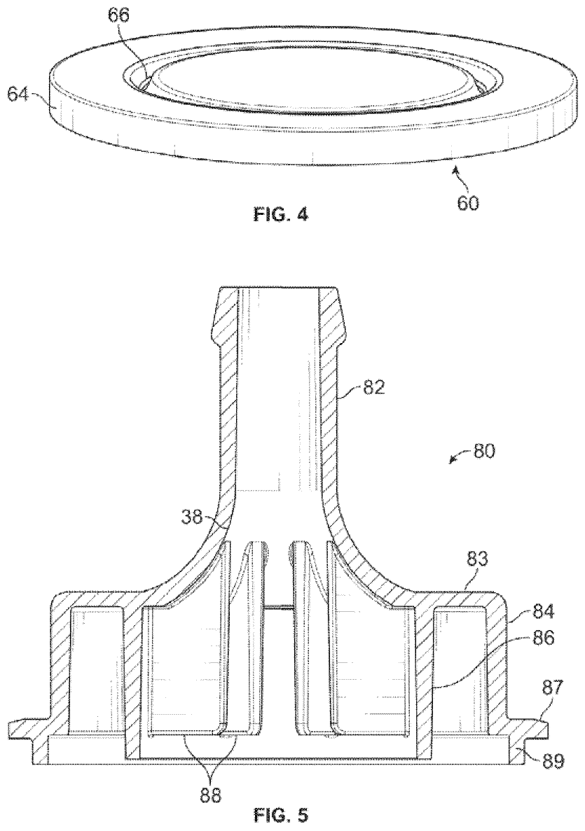

As shown in FIGS. 1 and 4, the screen 60 includes an outer impression 64 and an inner impression 66. As shown in FIG. 1, the outer impression 64 is sized and positioned to be received within the outer groove 28 and form a seal with the outer protrusion 29 of the outer cylinder 20. The inner impression 66 is sized and positioned to be received within the inner groove 48 and form a seal with the inner protrusion 49 of the inner cylinder 40. The outer impression 64 and the inner impression 66 may each have a U or V shaped cross section that extends circumferentially about the central axis 36, depending on the desired configuration and the assembly process.

As shown in FIG. 4, the screen 60 is continuous within the area defined by the outer impression 64. Accordingly, the screen 60 extends radially between and is continuous between the outer impression 64 and the inner impression 66. Additionally, the inner area defined by the inner impression 66 is completely filled by the screen 60.

### Example Endcap

As shown in FIG. 1, the endcap 80 is positioned axially on top of the screen 60 and is positioned along the first outer end 21 of the outer cylinder 20 and the first inner end 41 of the inner cylinder 40 to join the outer cylinder 20 and the inner cylinder 40 together. Since the outer cylinder 20 is closed along the second outer end 22 (with the lower wall 23), the DI filter assembly 10 only includes one single endcap (i.e., the endcap 80).

As shown in FIGS. 1 and 5, the endcap 80 includes an inlet 81 (e.g., an inlet passage) through which fluid flows into the DI filter assembly 10 (e.g., into the annulus 30) and an outlet 82 (e.g., an outlet passage) through which fluid flows out from the DI filter assembly 10 (e.g., out from the inner cavity 34). The inlet 81 and the outlet 82 can be threaded internally or externally or can have quick connection using tubes and clamps. In other embodiments, a different connection mechanism is used to secure tubes to the inlet 81 and/or the outlet 82. The endcap 80 positions the inlet 81 and the outlet 82 to be on the same side of the outer cylinder 20 and the inner cylinder 40 (i.e., along the first outer end 21 and the first inner end 41) as each other.

As shown in FIG. 1, the endcap 80 includes an endcap outer circumferential wall 84 that is radially aligned with the outer cylinder circumferential wall 24 of the outer cylinder 20 and extends circumferentially around the center of the endcap 80 (in particular around the endcap inner circumferential wall 86). As shown in FIGS. 1 and 5, the endcap 80 includes an endcap inner circumferential wall 86 (e.g., a separating wall) that fluidly separates the inlet 81 and the outlet 82. The endcap inner circumferential wall 86 is positioned within and surrounded by the endcap outer circumferential wall 84. A lower portion of the endcap inner circumferential wall 86 is configured to be received within the inner groove 48 of the inner cylinder 40 and the inner impression 66 of the screen 60 and form a seal with the inner surface of the inner protrusion 49 and the inner impression 66 when assembled with the inner cylinder 40 and the screen 60.

As shown in FIG. 5, the endcap 80 includes an upper wall 83 that is positioned along the top ends of the endcap outer circumferential wall 84 and the endcap inner circumferential wall 86. Accordingly, the endcap outer circumferential wall 84 and the endcap inner circumferential wall 86 each extend from an inner (bottom) surface of the upper wall 83 of the endcap 80. The upper wall 83 extends radially between the endcap outer circumferential wall 84 and the endcap inner circumferential wall 86.

As shown in FIG. 1, the inlet 81 of the endcap 80 extends tangentially to the endcap outer circumferential wall 84, thereby directing the fluid entering into the DI filter assembly 10 to flow into the screen 60 and the outer resin bed 32 in the outer cylinder 20 tangentially. By directing the fluid to enter the DI filter assembly 10 tangentially, the fluid 19 is uniformly and evenly distributed at the inlet 81 to flow to and throughout the outer cylinder 20, thereby ensuring that the fluid 19 flows uniformly through the annulus 30 and the outer resin bed 32 (and subsequently into the inner cylinder 40) and improving resin utilization.

As shown in FIG. 5, the outlet 82 of the endcap 80 is positioned at the radial center of the endcap 80 such that the outlet 82 is concentric with the outer cylinder 20 and the inner cylinder 40. The center axis of the outlet 82 (e.g., the central axis 36) is oriented (e.g., rotated) approximately 90° offset with respect to the center axis of the inlet 81. An inner surface 38 of the outlet 82 extends radially inwardly from the top end of the endcap inner circumferential wall 86 (e.g., the first inner end 41 in FIG. 1) and is continuous, streamlined, and tapers axially from the endcap inner circumferential wall 86 with a gradual profile. With the gradual profile of the outlet 82, the outlet 82 provides a smooth exit for the fluid (e.g., the fluid 19 in FIG. 1) to flow along and smoothens the transition of the flow passage from the width of the inner cylinder (e.g., the inner cavity 34 in FIG. 1) to the width of the outlet 82. The taper of the outlet 82 allows uniform flow distribution at the portion of the inner resin bed 52 that is close to the outlet 82, reduces the overall pressure drop or loss at the outlet 82 across the inner resin bed 52, and ensures that the inner resin bed 52 near the outlet 82 is fully utilized.

As further shown in FIGS. 1 and 5, the endcap 80 includes at least one endcap rib 88 to support the screen 60. Preferably, the endcap 80 includes a plurality of endcap ribs 88 that form an endcap rib structure. The endcap ribs 88 are positioned within the outlet 82 and extend axially downwardly from an inner surface of the outlet 82 and radially inwardly from the inner surface of the endcap inner circumferential wall 86. The endcap ribs 88 are spaced apart from each other in the center of the endcap 80.

As shown in FIGS. 1 and 5, the endcap 80 includes an outer lip 87 that extends radially outwardly from the outer surface of the endcap outer circumferential wall 84 (along the lower end of the endcap outer circumferential wall 84, opposite the upper wall 83). When assembled with the outer cylinder 20, the outer lip 87 extends radially over the entire outer groove 28 formed by the outer protrusion 29 of the outer cylinder 20.

The endcap 80 further includes a lower extension 89 that extends axially downwardly from a bottom surface of the outer lip 87 and is positioned radially outwardly relative to the endcap outer circumferential wall 84. The lower extension 89 is receivable within the outer groove 28 of the outer cylinder 20 and the outer impression 64 of the screen 60 and forms a seal with the inner surface of the outer protrusion 29 and the outer impression 64 when assembled with the outer cylinder 20 and the screen 60. In some embodiments, the DI filter assembly 10 includes a seal member (e.g., a gasket, an O-ring, etc.) disposed within the inner surface of the outer protrusion 29 to facilitate sealing between the screen 60, the outer cylinder 20 and the inner cylinder 40.

### Example Pressure Relief Mechanism

As shown in FIG. 6A, in one embodiment, the DI filter assembly 10 is positioned downstream of a coolant pump 96 and upstream of a fuel cell stack 98. According to some embodiments, the DI filter assembly 10 includes a pressure relief mechanism 90, as shown in

FIG. 6B. The flow bypass or pressure relief valve or mechanism 90 may be positioned within the endcap 80. The pressure relief mechanism 90 can be, for example, a simple orifice, a spring-loaded valve, an umbrella valve, or a duckbill valve.

In one embodiment, the pressure relief mechanism 90 is mounted directly into the main coolant line and is positioned in series with the fuel cell stack 98. The pressure relief mechanism 90 is configured to bypass any excess flow to the fuel cell stack and to only allow partial coolant flow (that is suitable to the design, based on a cross-sectional flow area and/or porosity of the resin beds, for example) to pass through the outer resin bed 32 and the inner resin bed 52. The pressure relief mechanism 90 effectively controls the flow velocities of the fluid through the outer resin bed 32 and the inner resin bed 52 and can be configured to provide optimized flowrates through the DI filter assembly 10 that maximize the ion exchange capacity.

The pressure relief mechanism 90 is configured to reduce the risk of resin overpacking, which can result in high pressure pulses that can reduce the performance of the DI filter assembly 10. In particular embodiments, the pressure relief mechanism 90 is configured to bypass fluid flow between the inlet 81 and the outlet 82 when an applied pressure along an axial direction through the resin bed (e.g., along a flow direction through the resin beds, etc.) is greater than or equal to a bypass threshold pressure (e.g., approximately 2 bar, etc.) to avoid resin overpacking, which can increase the change in pressure drop across the resin bed(s) and reduce the resin utilization. Resin overpacking occurs when the upstream fluid pressure of the fluid compresses the outer resin bed 32 or the inner resin bed 52 and increases the packing density (or reduces the porosity) of the outer resin bed 32 or the inner resin bed 52. Increasing the packing density increases the resistance to fluid (e.g., coolant) flow, thereby reducing an amount of fluid flow that can pass through the DI filter assembly 10.

### Example Method of Assembling a DI Filter Assembly

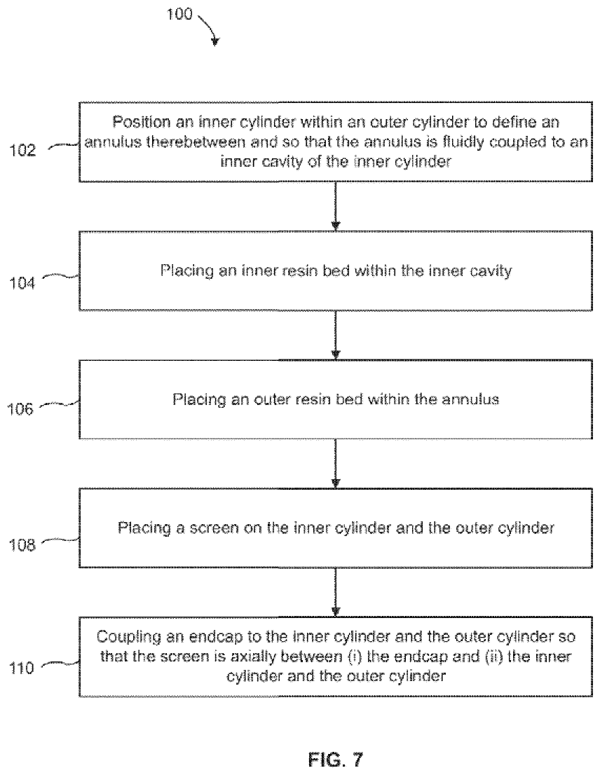

Referring to FIG. 7, a method 100 of assembling a DI filter assembly is shown, according to an embodiment. The method 100 may be used to form the DI filter assembly 10 of FIG. 1. In other embodiments, the method 100 may include additional, fewer, and/or different operations.

Operation 102 includes positioning an inner cylinder within an outer cylinder to define an annulus therebetween. Operation 102 includes positioning the inner cylinder within the outer cylinder so that the annulus is fluidly coupled to an inner cavity of the inner cylinder. In one embodiment, operation 102 includes coaxially aligning the inner cylinder with the outer cylinder by engaging at least one axial rib of the inner cylinder with an inner wall of an outer cylinder circumferential wall of the outer cylinder (or at least one axial rib of the outer cylinder with an outer surface of an inner cylinder circumferential wall of the inner cylinder). In one embodiment, operation 102 includes engaging at least one rib of the inner cylinder (e.g., an elevation rib, an elevation rib portion of an axial rib, etc.) that extends axially away from an inner cylinder circumferential wall of the inner cylinder with a lower wall of the outer cylinder at a closed end of the outer cylinder so that the inner cylinder circumferential wall is spaced axially apart from the lower wall.

Operation 104 includes placing an inner resin bed within the inner cavity. In one embodiment, operation 104 includes inserting a wire mesh containing resin beads within an inner cavity of the inner cylinder so that the inner resin bed completely fills the inner cavity of the inner cylinder.

Operation 106 includes placing an outer resin bed within the annulus between the inner cylinder and the outer cylinder. In one embodiment, operation 106 includes inserting a wire mesh containing resin beads within the annulus to completely fill the annulus. In some embodiments, operation 106 includes inserting the inner resin bed into the outer cylinder at the same time as the outer resin bed (e.g., with the inner cylinder, etc.).

Operation 108 includes placing a screen on the inner cylinder and the outer cylinder at an open end of the outer cylinder. In one embodiment, operation 108 includes inserting an outer impression of the screen into an outer groove formed in the outer cylinder and an inner impression of the screen into an inner groove of the inner cylinder. In some embodiments, operation 108 includes sealingly engaging the screen with the inner cylinder and the outer cylinder. In other embodiments, operation 108 includes inserting a first screen onto the inner cylinder and a second screen that is separate from the first screen onto the outer cylinder.

Operation 110 includes coupling an endcap to the inner cylinder and the outer cylinder so that the screen is disposed axially between (i) the endcap and (ii) the inner cylinder and the outer cylinder. In one embodiment, operation 110 includes coaxially aligning an outlet of the endcap with the inner cylinder and/or the outer cylinder. In one embodiment, operation 110 includes inserting a lower extension of the endcap into an outer groove of the outer cylinder to sealingly engage the endcap with the outer cylinder.

Each of the various embodiments disclosed herein may have any of the aspects, features, components, and/or configurations of the other embodiments, except where noted otherwise.

As utilized herein, the term “approximately” and similar terms are intended to have a broad meaning in harmony with the common and accepted usage by those of ordinary skill in the art to which the subject matter of this disclosure pertains. The term “approximately” as used herein refers to +5% of the referenced measurement, position, or dimension. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “attached,” and the like as used herein mean the joining of two members directly to one another. Such joining may be stationary (e.g., permanent) or moveable (e.g., removable or releasable).

References herein to the positions of elements (e.g., “top,” “bottom,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, the position of elements may be reversed or otherwise varied, and the nature or number of discrete elements or positions may be altered or varied. The order or sequence of any process or method steps may be varied or re-sequenced according to alternative embodiments. Other substitutions, modifications, changes, and omissions may also be made in the design, operating conditions and arrangement of the various exemplary embodiments without departing from the scope of the present invention.

What is claimed is:

1. A deionization filter assembly, comprising:
an outer cylinder comprising a first outer end and a second outer end, the outer cylinder configured to contain an outer resin bed;
an inner cylinder positionable within the outer cylinder and comprising a first inner end and a second inner end, the inner cylinder configured to contain an inner resin bed;
an endcap positionable along the first outer end of the outer cylinder and the first inner end of the inner cylinder and comprising an inlet and an outlet; and
a screen positionable between the endcap and the outer cylinder and the inner cylinder.

2. The deionization filter assembly of claim 1, wherein the first outer end of the outer cylinder is open to fluid flow therethrough and the second outer end of the outer cylinder is closed to fluid flow therethrough.

3. The deionization filter assembly of claim 2, wherein when assembled the inner cylinder extends between an inner surface of a lower wall positioned along the second outer end of the outer cylinder and the first outer end of the outer cylinder.

4. The deionization filter assembly of claim 1, wherein the inner cylinder includes an axial rib portion extending radially away from an outer surface of the inner cylinder, and an elevation rib extending axially away from the second inner end of the inner cylinder.

5. The deionization filter assembly of claim 1, wherein the endcap comprises an endcap outer circumferential wall that is radially aligned with an outer cylinder circumferential wall of the outer cylinder, the inlet of the endcap extending tangentially to the endcap outer circumferential wall.

6. The deionization filter assembly of claim 1, wherein the endcap comprises an endcap outer circumferential wall that is radially aligned with an outer cylinder circumferential wall of the outer cylinder, the outlet of the endcap tapering axially from the endcap outer circumferential wall.

7. The deionization filter assembly of claim 1, wherein the screen is positionable along the first outer end of the outer cylinder and the first inner end of the inner cylinder.

8. The deionization filter assembly of claim 7, wherein the screen includes (i) an outer impression positioned to be received within an outer groove at the first outer end of the outer cylinder, and (ii) an inner impression positioned to be received within an inner groove at the first inner end of the inner cylinder.

9. The deionization filter assembly of claim 1, further comprising a pressure relief mechanism that is configured to bypass fluid flow between the inlet and the outlet when an applied pressure across the inner resin bed and the outer resin bed is greater than or equal to a bypass threshold pressure.

10. A deionization filter assembly, comprising:
an outer cylinder defining an open end and a closed end;
an inner cylinder positioned within the outer cylinder and spaced radially apart from the outer cylinder to define an annulus therebetween, the inner cylinder defining an inner cavity that is fluidly coupled to the annulus at the closed end of the outer cylinder;
an outer resin bed contained within the annulus; and
an inner resin bed contained within the inner cavity.

11. The deionization filter assembly of claim 10, the inner cylinder comprising:
an inner cylinder circumferential wall; and
at least one elevation rib that extends axially away from the inner cylinder circumferential wall, the at least one elevation rib spacing the inner cylinder circumferential wall axially apart from the closed end of the outer cylinder to define a flow passage between the annulus and the inner cavity.

12. The deionization filter assembly of claim 10, wherein a height of the inner cylinder is approximately equal to a height of the annulus.

13. The deionization filter assembly of claim 10, wherein the inner cylinder includes an inner cylinder circumferential wall that is open to fluid flow axially therethrough from a first inner end of the inner cylinder through a second inner end of the inner cylinder.

14. The deionization filter assembly of claim 10, wherein the outer cylinder includes an outer cylinder circumferential wall, the inner cylinder including:
an inner cylinder circumferential wall; and
at least one axial rib extending radially away from the inner cylinder circumferential wall, the at least one axial rib radially spacing the inner cylinder circumferential wall and the outer cylinder circumferential wall apart to form the annulus.

15. The deionization filter assembly of claim 10, further comprising:
an endcap coupled to the inner cylinder and the outer cylinder at the open end of the outer cylinder; and
a screen positioned between the endcap and the outer cylinder and the inner cylinder.

16. The deionization filter assembly of claim 15, wherein the endcap includes:
an endcap outer circumferential wall radially aligned with an outer cylinder circumferential wall of the outer cylinder,
an inlet extending tangentially to the endcap outer circumferential wall, and
an outlet tapering axially from the endcap outer circumferential wall.

17. The deionization filter assembly of claim 15, wherein the screen includes (i) an outer impression positioned within an outer groove at the open of the outer cylinder, and (ii) an inner impression positioned within an inner groove at a first inner end of the inner cylinder.

18. A method of assembling a deionization filter assembly, comprising:
positioning an inner cylinder within an outer cylinder to define an annulus therebetween and so that the annulus is fluidly coupled to an inner cavity of the inner cylinder at a closed end of the outer cylinder;
placing an inner resin bed within the inner cavity; and
placing an outer resin bed within the annulus.

19. The method of claim 18, further comprising:
placing a screen on the inner cylinder and the outer cylinder at an open end of the inner cylinder and the outer cylinder; and
coupling an endcap to the inner cylinder and the outer cylinder so that the screen is disposed axially between (i) the endcap and (ii) the inner cylinder and the outer cylinder.

20. The method of claim 19, wherein positioning the inner cylinder within the outer cylinder includes engaging at least one rib of the inner cylinder that extends axially away from an inner cylinder circumferential wall of the inner cylinder with a lower wall of the outer cylinder at the closed end of the outer cylinder so that the inner cylinder circumferential wall is spaced axially apart from the lower wall.
